(19) United States
(12) Patent Application Publication
(10) Pub. No.: US 2006/0240970 A1
(43) Pub. Date: Oct. 26, 2006

(54) Glass compositions for the production of lead-free crystals

(75) Inventors: Antonio Telhado Pereira, Araxa (BR); Frederico Werner Strauss, Blumenau (BR); Debora da Silva, Gaspar (BR)

Correspondence Address: BIRCH STEWART KOLASCH & BIRCH, PO BOX 747, FALLS CHURCH, VA, 22040-0747, US

(73) Assignee: COMPANHIA BRASILEIRA DE METALURGIA E MINERACAO, Sao Paulo, SP (BR)

(21) Appl. No.: 10/540,727

(22) PCT Filed: Dec. 19, 2003
(86) PCT No.: PCT/BR03/00199

§ 371 Date: Apr. 26, 2006

(30) Foreign Application Priority Data
Jan. 14, 2003 (BR) PIO300042-7

(51) Int. Cl. C03C 3/078

(52) U.S. Cl. 501/72

(57) ABSTRACT

The invention refers to glass compositions for the production of lead-free crystals, having a density greater than 2.4 g/cm3, a refractory index of at least 1.51 and high resistance to chemical attack, characterized by comprising, by weight: from about 50% to about 75% of SiO2; from about 0.1% to about 1% of As2O3; from about 5% to about 15% of K2O; from about 2% to about 6% of Na2O; from about 3% to about 12% of CaO; from about 0.1% to about 5% of BaO; from about 0.1% to about 10% of Nb2O5; and, up to 5% of other elements.

### TECHNICAL FIELD

Present invention refers to glass compositions for the production of lead-free crystals, having a density greater than 2.4 g/cm³ and a refractory index of at least 1.51, that may be used for the production of fine tableware and decorative objects with similar characteristics (sound, brilliance, transparency, malleability) to those found in objects made with a formulation of 24% PbO.

The necessity to produce new types of glass with the same characteristics of crystal with 24% of PbO stems from the fact that lead, as well as its components; presents certain toxicity when in direct contact with humans. For this reason, whenever it is technically possible, one should opt for less toxic alternative products.

The proposal of the present invention is the substitution of lead with niobium in glass compositions.

### BACKGROUND OF THE INVENTION

Due to lead's toxicity, this invention has come with the proposal of removing it from the basic formulation of crystal, replacing it with niobium, which is totally inert, presenting no risk to those who handle it or come into direct contact with it.

Due to this, research has been carried out in the search for materials that can substitute lead in fine tableware crystal. It is known that, even if in small amounts, lead can separate from the glass.

U.S. Pat. No. 6,333,288 on optical glass, discloses that Nb₂O₅ and La₂O₃ increase the refractory index. Besides this, both components can increase the transmission of the glass.

U.S. Pat. No. 4,224,074 concerning raw materials for glass, discloses that the use of ZrO₂ increases the refractory index and offers exceptional chemical durability. It also discloses that TiO₂ and HfO can be added to increase the refractory index.

European patent application EP 0594422A, referring to the composition of glass, discloses that when the percentage of TiO₂ is less than 5%, the target values for refractory and dispersion indexes cannot be obtained. On the other hand, when the percentage of TiO₂ exceeds 8%, the tendency for the appearance of yellow coloring increases significantly; this being an undesired quality for crystal where transparency is very important.

U.S. Pat. No. 6,184,166 discloses compositions for lead-free glass, where the PbO is substituted with ZnO. This substitution, along with the alkaline oxide control, offers the desired characteristics of viscosity, previously achieved with the use of lead oxide. Nowadays, glass, containing zinc oxide, has better resistance than the ones containing lead oxide, besides offering enhanced durability in reference to chemical attack. Nevertheless, it is known that ZnO introduced into glass mixture can contain relatively high levels of CdO, a highly toxic substance, even in low concentrations.

### SUMMARY OF THE INVENTION

Thus, the purpose of the present invention is to provide glass compositions for the production of lead-free crystals, having a density greater than 2.4 g/cm³, a refractory index of at least 1.51 and high resistance to chemical attack, characterized by comprising, by weight: from about 50% to about 75% of SiO₂; from about 0.1% to about 1% of As₂O₃; from about 5% to about 15% of K₂O; from about 2% to about 6% of Na₂O; from about 3% to about 12% of CaO; from about 0.1% to about 5% of BaO; from about 0.1% to about 10% of Nb₂O₅; and, up to 5% of other elements.

In a particular embodiment, the composition comprises, by weight: from about 60% to about 75% of SiO₂; from about 0.1% to about 1% of As₂O₃; from about 6% to about 15% of K₂O; from about 2% to about 6% of Na₂O; from about 3% to about 10% of CaO; from about 0.1% to about 5% of BaO; from about 0.1% to about 10% of Nb₂O₅; and, up to 5% of other elements.

In the composition:

Silica (SiO₂) is responsible for the basic network formation of glass;

The percentages of Na₂O and K₂O work as modifiers of the network and act as fluxes, facilitating the crystal casting. Adverse effects are that excessive increases of these components increase the thermal expansion coefficient which is usually undesirable and diminishes the chemical durability.

CaO is the most important earthy alkaline for the formation of glass.

BaO and CaO can be used to assure the high density and the high refractory index.

Nb₂O₅ is used to increase the refractory index as well as the chemical and physical resistance of the crystal.

Among the additives which facilitate refining, As₂O₃ can be used up to the amount of 1%. The crystal can even contain discoloration agents such CoO, NiO, and Nd₂O₃.

The measurement of the refractory index was carried out with the help of a Abbe Refractometer from Atago. For the hardness measurement a Future Tech Corporation FM micro-hardness meter was used, with a semi-automatic reading device. The identification load was 50 g. The analyses were carried out on polished glass surfaces and 7 measurements were made for each sample. The refractory index and micro-hardness tests were performed in the Vitreous Materials Laboratory (LaMaV) at the Federal University of São Carlos.

The thermal expansion coefficient measurement was done in accordance with the Annex K of Brazilian Norm NBR 13818:1997. This analysis was carried out at the Material Characterization and Development Center (CCDM).

The thermal expansion coefficient determination test revealed the following data:

The Annealing Point (AP): The annealing point corresponds to the maximum temperature in the annealing range in which the internal force of the glass will be substantially eliminated.

The Softening Point (SP): The softening point is the temperature at which the glass becomes deformed by its own weight.

The Glass Transition Temperature (Tg): The glass transition temperature is the temperature range at which the glass is gradually transformed from its solid state to its molding state. The transformation temperature can be determined through the thermal expansion curve.

The Thermal Expansion Coefficient (α): A mass expands when it is heated. Thermal expansion is the change relative to a given dimension when a mass is heated.

The chemical durability was tested by weighing the mass after being treated in pH 1 and neutral solutions, at different times, at a temperature of 50° C.

### DETAILED DESCRIPTION OF THE INVENTION

In order to overcome the inconveniences of lead-free crystals discussed earlier, a reformulation of the mixture is proposed (% in weight of oxide) for the manufacturing of lead-free glass objects described in tables 1 and 2 below:

TABLE 1
Chemical Properties of the Niobium Crystal
Chemical Properties

| Elements | Test 1 | Test 2 |
|---|---|---|
| % SiO₂ | 72 | 74 |
| % As₂O₃ | 0.3 | 0.3 |
| % K₂O | 10.6 | 11 |
| % Na₂O | 5.2 | 5.4 |
| % CaO | 5.1 | 5.3 |
| % BaO | 2 | 2 |
| % Nb₂O₅ | 4.6 | 1 |

TABLE 2
Physical Properties of the Niobium Crystal
Physical Properties

| Property | Test 1 | Test 2 |
|---|---|---|
| (S.P.) ° C. | 592 | 577 |
| Tg ° C. | 521 | 516 |
| (α) × 10⁻⁷/° C. | 85.3 | 99.9 |
| Density (g/cm³) | 2.52 | 2.7 |
| nd | 1.52 | 1.51 |
| Hardness (Hv) kgf/mm² | 521 */− 8 | 502 +/− 5 |

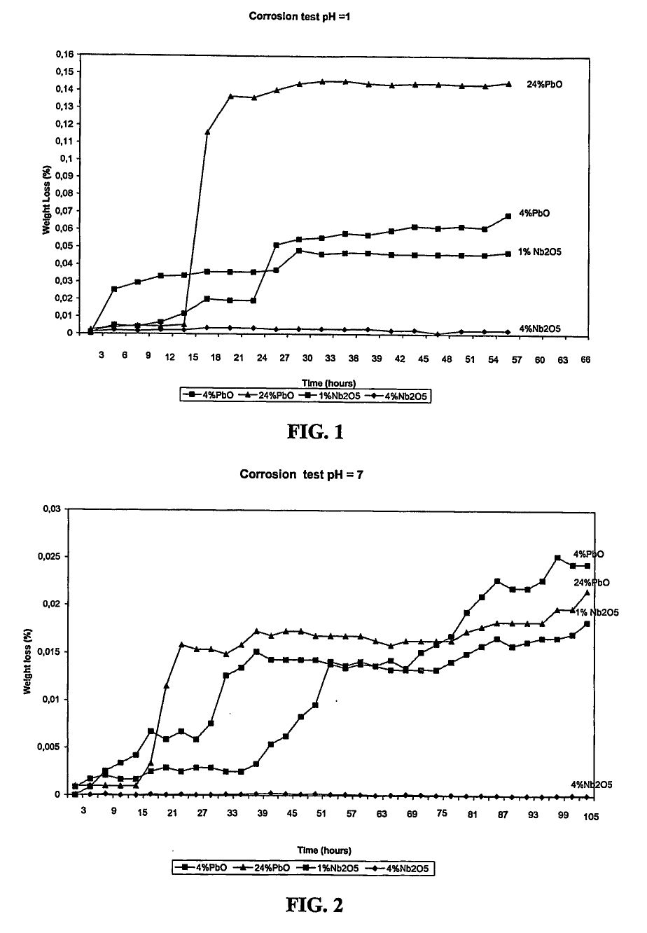

The chemical resistance of the samples (see Table 3) was evaluated by analyzing the weight loss after immersion in a neutral solution for periods up to 105 hours and in a pH 1 solution up to 57 hours. The results are shown in FIGS. 1 and 2 and it may be observed that the samples that contain Nb₂O₅ suffered less chemical attack.

TABLE 3
Percentage of Nb₂O₅ and PbO in the Tests Analyzed

| Sample | % Nb₂O₅ | PbO |
|---|---|---|
| 4% PbO | 0 | 4 |
| 24% PbO | 0 | 24 |
| 4% Nb₂O₅ | 4 | 0 |
| 1% Nb₂O₅ | 1 | 0 |

1. Glass compositions for the production of lead-free crystals, having a density greater than 2.4 g/cm³, a refractory index of at least 1.51 and high resistance to chemical attack, characterized by comprising, by weight: from about 50% to about 75% of SiO₂; from about 0.1% to about 1% of As₂O₃; from about 5% to about 15% of K₂O; from about 2% to about 6% of Na₂O; from about 3% to about 12% of CaO; from about 0.1% to about 5% of BaO; from about 0.1% to about 10% of Nb₂O₅; and, up to 5% of other elements.

2. The glass compositions of claim 1, characterized by comprising, by weight: from about 60% to about 75% of SiO₂; from about 0.1% to about 1% of As₂O₃; from about 6% to about 15% of K₂O; from about 2% to about 6% of Na₂O; from about 3% to about 10% of CaO; from about 0.1% to about 5% of BaO; from about 0.1% to about 10% of Nb₂O₅; and, up to 5% of other elements.
